(19) United States
(12) Patent Application Publication
(10) Pub. No.: US 2005/0084190 A1
(43) Pub. Date: Apr. 21, 2005

(54) Variable vane electro-graphitic bushing

(76) Inventors: Robert T. Brooks, Killingworth, CT (US); Mark B. Gossner, Durham, CT (US); Scott R. Kreamer, West Hartford, CT (US)

Correspondence Address: BACHMAN & LAPOINTE, P.C., 900 CHAPEL STREET, SUITE 1201, NEW HAVEN, CT, 06510, US

(21) Appl. No.: 10/685,610

(22) Filed: Oct. 15, 2003

(51) Int. Cl. F16C 33/02

(52) U.S. Cl. 384/276

(57) ABSTRACT

A method for improving the wear characteristics of ID bushings comprising the steps of providing an ID bushing comprising electro-graphitic carbon.

### BACKGROUND OF THE INVENTION

(1) Field of the Invention

The present invention relates to a bushing constructed of electro-graphitic carbon for reducing wear in gas turbine trunnions.

(2) Description of the Related Art

In gas turbine engines, the variable vanes of the high compressor are held at the inner diameter by an inner diameter, or ID, trunnion bushing. With reference to FIG. 1, there is illustrated the construction of a portion of an engine including the ID bushing 23. The bushing 23 is situated between trunnion 15 and two ID shroud halves 22, 22′. A variable vane 17 is attached to trunnion 15 via platform 21.

The bushing 23 is assembled/clamped between the ID shroud halves 22 and is typically constructed of a wear resistant and low friction material. Typically, bushing 23 is fabricated from graphite filled polyimide materials capable of continuous operation up to 650° F. Unfortunately, a bushing 23 constructed of such polymides is not capable of withstanding the high temperatures and loads of advanced high performance compressors. At present, bushings 23 are limited to 650° F. to 700° F. peak excursions as extended periods of exposure tend to rapidly degrade the bushing 23 resulting in metal to metal contact between the trunnion 15 and the ID shrouds 22, 22′. The negative aspects arising from such metal to metal contact are two-fold. Firstly, the metal to metal contact serves to degrade, and destroy, the physical trunnion 15 and ID shrouds 22, 22′ resulting in a potentially catastrophic engine failure mode by wearing through the trunnion 15, liberating, and entering the engine core. Secondly, such metal to metal contact serves to wear away the trunnion 15 and the ID shrouds 22, 22′ so as to alter the physical geometry of both. As the geometry of the parts change, the tightness of the fit between the trunnion and the ID shrouds 22, 22′ is similarly altered. Such an alteration in the geometry ultimately results in an angular displacement of a variable vane 17. Such displacement of variable vane 17 can be catastrophic. Specifically, if a variable vane 17 is displaced with respect to adjacent vanes by more than 6°, a catastrophic surge may be induced. It is therefore of the utmost importance that the trunnion 15 and ID shrouds 22, 22′ operate in such a manner as to maintain their shapes and, thus, maintain a constant variable vane 17 angle.

What is therefore needed is a self lubricating bushing 23 which does not suffer material breakdown at high temperatures and which serves to maintain the fit and orientation of ID shrouds 22, 22′ and trunnion 15 during and after thermal exposure.

### SUMMARY OF THE INVENTION

Accordingly, it is an object of the present invention to provide a bushing constructed of electro-graphitic carbon for reducing wear and improving thermal stability in gas turbine trunnions.

In accordance with the present invention, a method for improving the wear characteristics of ID bushings comprises the steps of providing an ID bushing comprising electro-graphitic carbon.

In accordance with the present invention, a wear resistant ID bushing comprises a bushing comprising electro-graphitic carbon.

In accordance with the present invention, a bushing assembly comprises an ID bushing comprising electro-graphitic carbon, a trunnion, and an ID shroud wherein the ID bushing is located in contact with the trunnion and the ID shroud.

### BRIEF DESCRIPTION OF THE DRAWINGS

FIG. 1 A diagram of the gas turbine engine ID bushing assembly of the present invention.

FIG. 2 A cross-section diagram of an electro-graphitic carbon bushing 23 of the present invention.

### DETAILED DESCRIPTION

It is a central teaching of the present invention to disclose an inner diameter, or ID, bushing 23 composed of a graphite based substance, preferably electro-graphitic carbon. The ID bushing 23 of the present invention does not suffer significant breakdown even at temperatures approximating 1050° F. In addition, the ID bushing 23 of the present invention both self lubricates as well as maintains the appropriate distance between ID shrouds 22, 22′ and the trunnion 15. As a result, the ID bushing 23 of the present invention may operate for extended periods of time at high temperatures while maintaining its geometry so as to avoid unwanted deflection of the variable vane.

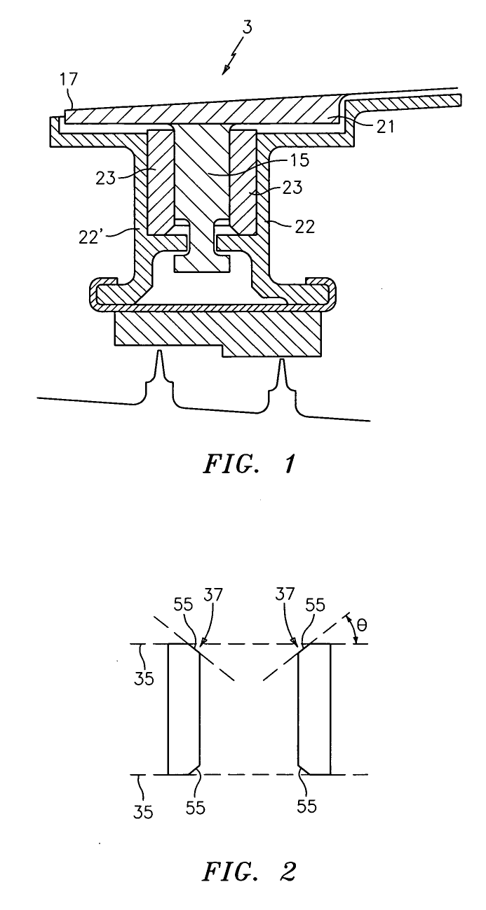

With reference to FIG. 1, there is illustrated the bushing assembly 3 of the present invention. ID bushing 23 is generally cylindrical and is situated between ID shrouds 22, 22′ and trunnion 15. With reference to FIG. 2, there is illustrated in detail a cross-section of an ID bushing 23 of the present invention. As noted, ID bushing 23 is fabricated from a carbon based substance, preferably electro-graphitic carbon. With ID bushing 23 thusly formed, it is preferable to chamfer or otherwise machine the ID bushing 23. Were one to allow ID bushing 23 to extend at either end parallel to normal line 35, the result would be an increase in the probability of damage to the ID bushing 23. In operation, the stresses transmitted to the trunnion 15 and bushing 23 from the variable vane 17 can be substantial. These forces serve to encourage the trunnion 15 and bushing 23 to rock in a pendulum-like motion away from being parallel to bushing centerline 31. As a result of this rocking motion, severe stress is applied to the ends of the ID bushing 23 nearest to normal line 35. If the interior edge of ID bushing 23 were to remain a right angle, these forces could cause ID bushing 23 to chip or otherwise fragment. It is therefore preferable to machine a chamfer 37 into the interior edges of ID bushing 23. In a preferred embodiment, the angle θ between the chamfered surface 55 of ID bushing 23 extending at an angle θ from normal line 35 is between 5 and 85°. Most preferably, the chamfer angle θ is approximately 45°. While illustrated with respect to a chamfer surface 55 extending in a linear fashion at a chamfer angle θ, the present invention is not so limited. Rather, the present invention is drawn broadly to encompass any and all shapes to which chamfer surface 55 might be machined including but not limited to curves.

In operation, the bushing 23 of the present invention has been seen to experience no wear of the trunnion after durations of operation in excess of forty hours. It was observed that, as the trunnion rotated and moved with respect to the ID bushing 23, and subsequently wore upon ID bushing 23, the electro-graphitic carbon of the ID bushing 23 adhered to and filled voids created in the outer surface of the trunnion 15. In this manner, the electro-graphitic carbon of the ID bushing 23 was self lubricating and acted to provide a very stable lubricious graphite-to-graphite contact surface. In addition, as the graphite distributed itself about the trunnion 15, the total volume of the graphite remained unchanged. As a result, there was maintained a constant spacing between the trunnion 15 and the ID shrouds 22, 22′ equal to the original thickness of the ID shroud 23. The geometry of the trunnion 15 with respect to the ID shrouds 22, 22′ remained constant and therefore avoided any unwanted deflection of the variable vane 17.

Tests conducted at 850° F. confirm that the ID bushing 23 of the present invention exhibits a 3.5× wear resistance over the bushings known in the art over a sixty-five hour period and continued to run up to 207 hours with the same amount of wear as polymide designed bushing experienced at sixty-five hours.

It is apparent that there has been provided in accordance with the present invention a bushing constructed of electro-graphitic carbon for reducing wear in gas turbine trunnions. which fully satisfies the objects, means, and advantages set forth previously herein. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

1. A method for improving the wear characteristics of ID bushings comprising the steps of:
providing an ID bushing comprising electro-graphitic carbon.

2. The method of claim 1 wherein said providing step comprises providing a turbine engine ID bushing.

3. The method of claim 1 wherein said providing step comprises fabricating a linear chamfer about an edge of said ID bushing said linear chamber extending at a chamfer angle.

4. The method of claim 3 wherein said fabricating said linear chamfer comprises fabricating said linear chamfer to a chamfer angle between 5° and 85°.

5. The method of claim 4 wherein said fabricating said linear chamfer comprises fabricating said linear chamfer at a chamfer angle of approximately 45°.

6. The method of claim 1 wherein said providing step comprises fabricating a curve into at least one edge of said ID bushing.

7. A wear resistant ID bushing comprising a bushing comprising electro-graphitic carbon.

8. The bushing of claim 7 wherein said ID bushing is a turbine engine bushing.

9. The bushing of claim 7 wherein said ID bushing comprises a linear chamfer extending at a chamfer angle.

10. The bushing of claim 9 wherein said chamfer angle is between 5° and 85°.

11. The bushing of claim 10 wherein said chamfer angle is approximately 45°.

12. The bushing of claim 7 comprising a curve fabricated into at least one edge of said ID bushing.

13. A bushing assembly comprising:
an ID bushing comprising electro-graphitic carbon;
a trunnion; and
an ID shroud wherein said ID bushing is located in contact with said trunnion and said ID shroud.
